(19) United States
(12) Patent Application Publication
(10) Pub. No.: US 2009/0248915 A1
(43) Pub. Date: Oct. 1, 2009

(54) COMMUNICATION CONTROL APPARATUS AND COMMUNICATION CONTROL METHOD

(75) Inventor: Mitsuru Sato, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/404,033

(22) Filed: Mar. 13, 2009

(30) Foreign Application Priority Data
Mar. 28, 2008 (JP) 2008-085371

(51) Int. Cl. G06F 13/20

(52) U.S. Cl. 710/36

(57) ABSTRACT

A communication control apparatus includes a communication terminal capable of performing communication with an external apparatus. The communication control apparatus includes virtual interfaces for separately receiving, through a communication terminal, plural sets of access information representing respective specifics of I/O accesses which are output to one I/O device from a plurality of virtual processing units in the external apparatus. The communication control apparatus includes a match determination unit for comparing the plural sets of access information received from the external apparatus by the virtual interfaces, and determining whether the plural sets of access information are matched with each other. The communication control apparatus includes an access control unit for, when the plural sets of access information received by the plurality of virtual interfaces are matched with each other, sending the relevant access information to the I/O device that is an access destination of the relevant access information.

### CROSS-REFERENCES TO RELATED APPLICATIONS

This application is related to and claims priority to Japanese Patent Application No. 2008-85371 filed on Mar. 28, 2008 in the Japan Patent Office, and incorporated by reference herein.

### FIELD

Embodiments disclosed herein are directed to a multiplexing technique for improving reliability of I/O access to an I/O device.

### BACKGROUND

In LSIs constituting a computer system, efforts toward finer structures and lower voltages have been advanced year by year to increase the operation frequency and to meet a demand for higher performance. On the other hand, the use of finer structures and lower voltages accompanies a factor causing an LSI to be more easily affected by disturbances, and reliability tends to reduce when each LSI is considered alone. In view of such a situation, a multiplex execution technique is proposed as a method for improving reliability of the execution result itself of a computer.

The multiplex execution technique is performed by executing the same program plural times, verifying whether execution results are matched with each other, and employing the result matched between or among the plural executions, thus assuring correctness of the result. When the same data is provided as an input, plural results obtained with repeated calculations should be the same unless a failure or other problems occur during any process of the calculations. Accordingly, the probability of having an error due to the failure or other problems that occur during the calculations can be reduced by confirming a match between or among the plural calculation results. FIG. 12 is an explanatory view illustrating a general multiplex execution technique. In FIG. 12, a plurality of calculation units are prepared and the same program and the same input data are applied to each of the calculation units. If the calculation results of the plural calculation units are matched with each other, it is confirmed that the calculation units have operated normally.

When a difference is found by comparing the calculation results of the plural calculation units, the result that is expected to be correct can be selected in accordance with a majority vote (i.e., a rule of majority decision) if there are three or more calculation results. If there are two calculation results, the discrepancy is coped with, for example, by a method of executing the calculations again or issuing a warning to a user. Further, when calculations are executed at the same time by using a plurality of calculation units, a more sophisticated process, such as disconnecting the calculation unit that has output the result differing from the other execution result, can also be employed on judgment that the relevant calculation unit has failed. See, for example, Japanese Laid-open Patent Publication No. H11-085713.

In trying to actually construct a system using the multiplex execution technique, a level of multiplexing is an important issue. More specifically, simplicity in construction, easiness of a match check, etc. significantly vary depending on which part of the “calculation unit” in FIG. 12, i.e., a microprocessor level (LSI level), a software level, or an I/O level, is selected as the multiplexing level. The multiplexing at the LSI level raises the problem that the multiplex execution technique cannot be applied to other systems than those using LSIs equipped with the function of the match check. Also, the multiplexing at the software level raises the problem that the power of a CPU is considerably consumed by the match check and deterioration of performance comes up.

On the other hand, the multiplexing at the I/O level is widely employed as a multiplexing technique with hardware. FIG. 13 illustrates a general configuration of a computer system. As illustrated in FIG. 13, a general computer system is constructed based on a node including a CPU and a memory. The node has an I/O bridge through which I/O access is performed. An I/O bus is connected to the I/O bridge. An I/O device, e.g., a network interface or a disk interface, is connected to the I/O bus. Thus, I/O access issued from the CPU is output to the I/O bus through the I/O bridge and is then sent to the I/O device as an access target.

FIG. 14 is a block diagram used to explain the multiplexing at the I/O level. For the multiplexing at the I/O level, a plurality (two in FIG. 14) of nodes are prepared and whether I/O accesses output from respective I/O bridges are matched with each other is detected. If the I/O accesses are not matched with each other, an error signal is output from a match detection circuit (check logic) on judgment that an error has occurred in the node. While FIG. 14 illustrates only an example of duplication, a variation can also be employed, for example, in which three or more nodes are connected to the match detection circuit and an error signal is sent to only the node for which the occurrence of an error has been determined in accordance with a majority vote.

As illustrated in FIG. 14, the multiplexing at the I/O level requires, as an essential, the match detection circuit for detecting a match between the I/O accesses output from the plural nodes. The configuration of the match detection circuit can be selectively set from among various options depending on, for example, what synchronization method is used to synchronize the nodes with each other, or how the I/O device connected to the match detection circuit is driven.

Hardware of a known highly-reliable system for implementing the multiplexing at the I/O level is primarily realized with the match detection circuit using the I/O bridge. In one example of that type of match detection circuit, another I/O bridge is inserted between the I/O bridge of each node and the I/O device (FIG. 15). In another example of that type of match detection circuit, a match check circuit (checker) is incorporated in the I/O bridge interconnecting the interior of each node and the I/O bus, and a match check is performed by receiving I/O access information from other plural nodes (or the partner node in the illustrated case because there are two nodes) and by comparing the received I/O information with the I/O access issued from the relevant node (FIG. 16).

The above-described known check methods using the I/O bridges have the following problems.

(1) Two or more nodes are physically needed.

As seen from FIGS. 15 and 16, two or more I/O buses are needed in order to perform the match check using the I/O bridges. Accordingly, two or more nodes providing the I/O buses have to be prepared. Meanwhile, the use of a multiplex execution environment using virtual machines has recently begun. A method using the virtual machines constructs a plurality of virtual nodes on one physical node and can realize the multiplex execution environment by preparing only one physical node. However, the above-described methods using the I/O bridges to perform the match check cannot be employed in the environment including one physical node.

(2) Access from I/O device side is not checked.

Although I/O access is generally performed from the CPU side, access is also made from the I/O device side to the interior of the node (particularly, to the contents of a memory) in some cases. The latter access does not need the match check in itself because that access is controlled from the I/O device side. On the other hand, the result read out with the access (i.e., the memory contents) represents information regarding the interior of the node and has to be subjected to the match check from the viewpoint of specific nature. However, the above-described known check methods using the I/O bridges operate in an asymmetric manner and are not adaptable for checking the specifics accessed by the I/O device.

The technique disclosed herein is to solve the problems described above and its object is to provide a technique for improving reliability of I/O access to an I/O device without employing a complicated apparatus configuration.

### SUMMARY

A communication control apparatus includes a communication terminal capable of performing communication with an external apparatus. The communication control apparatus includes a plurality of virtual interfaces for separately receiving, through the communication terminal, plural sets of access information representing respective specifics of I/O accesses which are output to one I/O device from a plurality of virtual processing units in the external apparatus. The communication control apparatus includes a match determination unit for comparing the plural sets of access information received from the external apparatus by the plurality of virtual interfaces, and determining whether the plural sets of access information are matched with each other. The communication control apparatus includes an access control unit for, when the match determination unit determines that the plural sets of access information received by the plurality of virtual interfaces are matched with each other, sending the relevant access information to the I/O device that is an access destination of the relevant access information.

### BRIEF DESCRIPTION OF THE DRAWINGS

Embodiments are illustrated by way of example and not limited by the following figures.

FIG. 1 illustrates a configuration of a multiplexing system including a communication control apparatus C according to a first embodiment;

FIG. 2 illustrates a detailed configuration of an I/O device illustrated in FIG. 1;

FIG. 3 is a flowchart illustrating a process flow from reception of I/O access by the I/O device to registration of the I/O access into a queue;

FIG. 4 is a flowchart illustrating a process flow from a match check made after taking out I/O access information registered in the queue to operation of the I/O device proper;

FIG. 5 is a flowchart illustrating a process flow when “I/O access for accessing a host from the I/O device” is generated from a device controller;

FIG. 6 illustrates a data structure in each of a queue 0 and a queue 1;

FIG. 7 illustrates a structure of data stored in the queue when the I/O access is a DMA request;

FIG. 8 illustrates a structure of an I/O device using three virtual interfaces according to a second embodiment;

FIG. 9 is a flowchart illustrating an operation flow in a voter;

FIG. 10 illustrates an overall configuration of a multiplexing system including a communication control apparatus according to a third embodiment;

FIG. 11 illustrates a detailed configuration of an I/O bridge 3″ illustrated in FIG. 10;

FIG. 12 is a block diagram used to explain a general multiplex execution technique;

FIG. 13 illustrates a general configuration of a computer system:

FIG. 14 is a block diagram used to explain multiplexing at an I/O level;

FIG. 15 is a block diagram used to explain one example of a match detection circuit using I/O bridges; and

FIG. 16 is a block diagram used to explain another example of a match detection circuit using I/O bridges.

### DESCRIPTION OF EMBODIMENTS

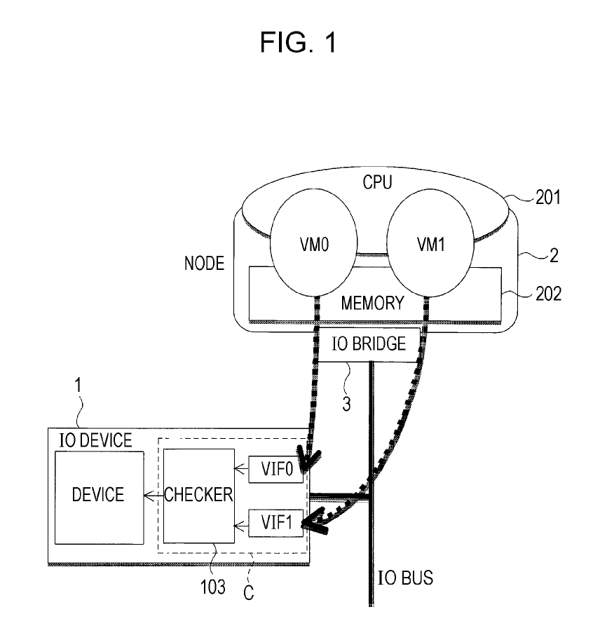

FIG. 1 illustrates respective configurations of a communication control apparatus C according to a first embodiment, an I/O device 1 including the communication control apparatus C, and a multiplexing system including the communication control apparatus C.

In the first embodiment, two virtual machines (VM0 and VM1) are operated by a host 2 that is physically one. VM0 and VM1 correspond to plural virtual processing units. These two virtual machines run the same program and execute the same logical and arithmetic processing. Verification as to whether the operations of the virtual machines VM0 and WM1 are matched with each other or not is performed by an I/O device 1 connected to a host 2 through an I/O bridge 3. The I/O device 1 includes virtual interfaces VIF0 and VIF1 corresponding respectively to the virtual machines VM0 and VM1. Herein, the acronym “VM” represents Virtual Machine, and the “VIF” represents Virtual Interface.

Whether accesses to the virtual interfaces VIF0 and VIF1 are matched with each other or not is checked by a checker (also referred to as a “comparator” later) 103 included in the I/O device 1. Only when a match between the accesses is confirmed by the checker 103, the actual operation of the I/O device is performed.

In FIG. 1, the virtual machines VM0 and VM1 share the same physical I/O device, but they access to different interfaces, i.e., the virtual interfaces VIF0 and VIF1.

The virtual machines VM0 and VM1 are realized with “virtual functions” specified in IOV (I/O Virtualization) of PCI Express.

Accordingly, I/O accesses delivered from the virtual machines VM0 and VM1 are distributed and sent to separate “virtual functions” in accordance with the IOV standards of PCI Express. For the method of designating the “virtual function”, etc., see “PCI Express Base Specification Revision 1.1” as written standards of PCI Express, and “Single Root I/O Virtualization and Sharing Specification Revision 1.0” as written standards of IOV.

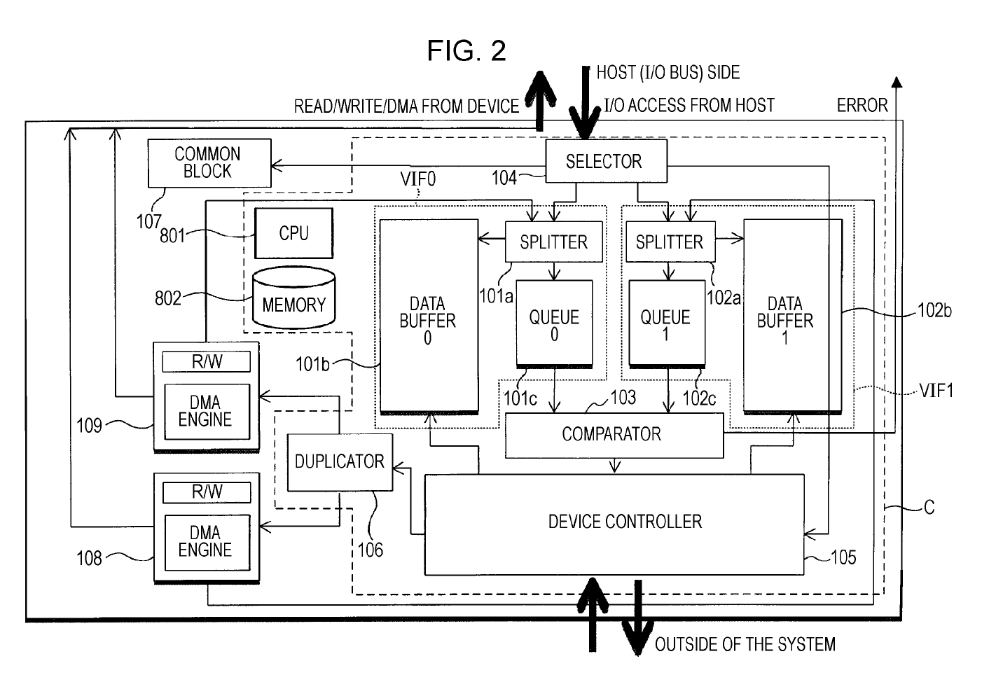

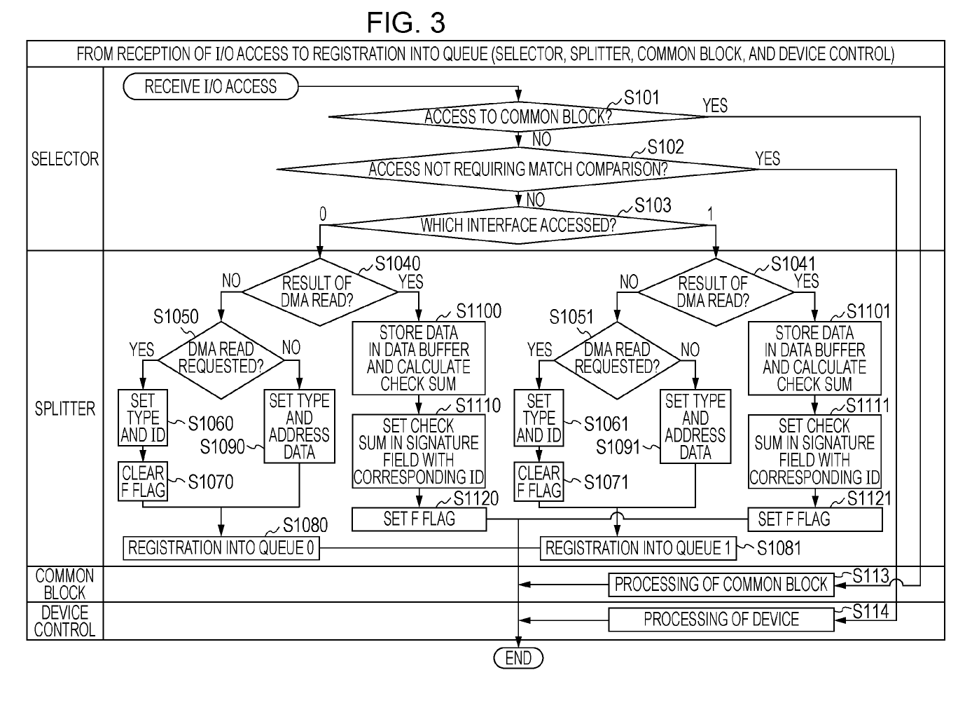

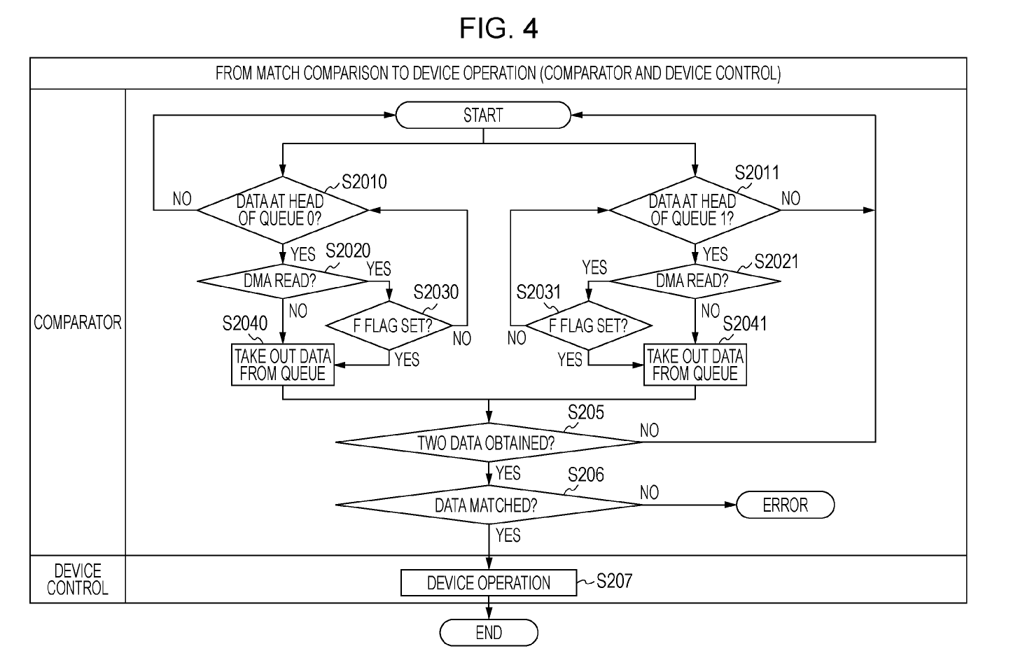

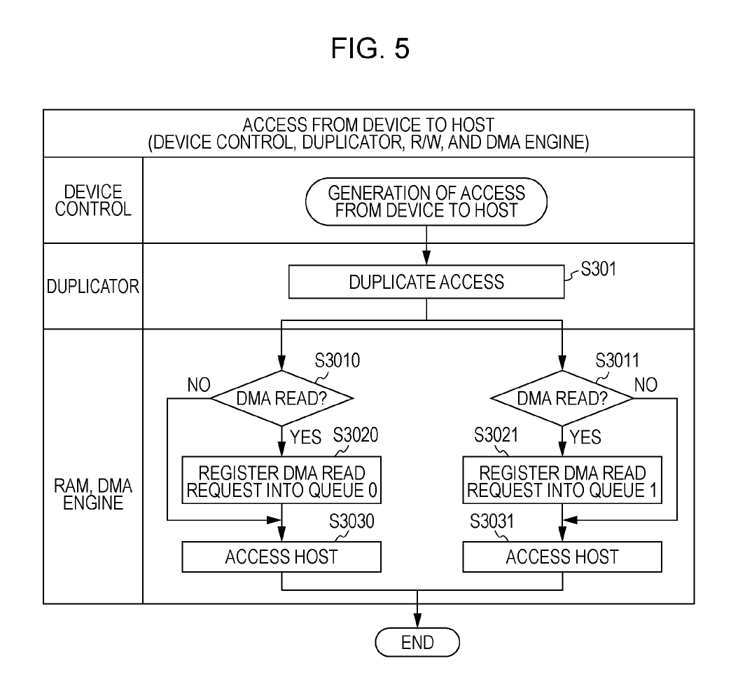

FIG. 2 illustrates a detailed configuration of the I/O device 1 illustrated in FIG. 1. FIG. 3 is a flowchart illustrating a process flow from reception of I/O access by the I/O device to registration of the I/O access into a queue. FIG. 4 is a flowchart illustrating a process flow from a match check made after taking out I/O access information registered in the queue to operation of the I/O device proper. FIG. 5 is a flowchart illustrating a process flow when “I/O access for accessing the host from the I/O device” is generated from a device controller.

The functions of various components inside the I/O device, illustrated in FIG. 2, will be described below.

A selector 104 classifies I/O accesses inputted through a physical interface depending on the access type. If the inputted I/O access is access that is preset to bypass the subsequent comparison process, the selector 104 sends the relevant I/O access directly to a device controller 105 without passing the relevant I/O access to a comparator 103. Further, if the inputted I/O access is access to the physical I/O device, e.g., access regarding setting of the device (Yes in S101 in FIG. 3), the selector 104 sends the relevant I/O access to a common block 107 (S113), which executes processing common to the components of the I/O device. If the inputted I/O access is other than the access to the physical I/O device (No in S101), the selector 104 determines, depending on the destination (VIF0 or VIF1) of the I/O access, whether the I/O access is to be sent to a splitter 101a or a splitter 102a. The function of distributing the destination of the I/O access to any of the common block 107, the VIF0, and the VIF1 by the selector 104 is the same as that provided by IOV of PCI Express. In other words, a section for distributing the I/O access sent from the host is constructed by adding, to the function in accordance with IOV of PCI Express, the function of directly sending the I/O access (Yes in S102), which needs no match check, to the device controller 105 (S114).

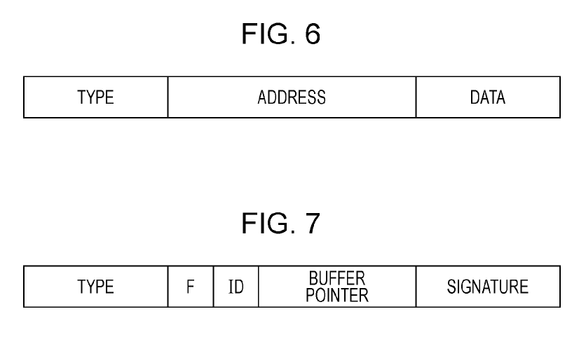

If the I/O access sent from the host is I/O access needing the match comparison (No in S102), each of the splitter 101a and the splitter 102a identifies the type of the sent I/O access (S103) for classification of the I/O access into control and data. In the case of ordinary I/O access, the I/O access is sent, as it is, to a queue 0 or a queue 1. FIG. 6 illustrates a data structure in each of the queue 0 and the queue 1. As seen from FIG. 6, the queue stores the type of the I/O access (Type), the accessed address (Address), and the write data (Data) when the I/O access is a write.

If the I/O access is a DMA (Direct Memory Access) request, the I/O access is stored in the queue in a different format (S1060, S1070, S1080, S1061, S1071 and S1081). FIG. 7 illustrates a structure of data stored in the queue when the I/O access is a DMA request.

If the I/O access is a DMA request (No in S1040) (No in S1041), the access type indicating whether the I/O access is a read (Yes in S1050) (Yes in S1051) or a write (No in S1050) (No in S1051) is stored as illustrated in FIG. 7 (S1060 and S1061). Further, a flag (F) indicating whether the result of DMA has been returned or not and the ID of DMA (ID) are also stored (S1060 and S1061). Moreover, the address type and the address data (Buffer Address (Pointer)) in a data buffer storing the result of DMA are stored (S1090 and S1091), and a signature (Signature) produced from the result of DMA is stored. Note that, at the time when the request arrives, the flag (F) is in a cleared state and Buffer Address and Signature are stored in respective blank fields.

If the I/O access is a data block that is obtained, for example, as a result of DMA (Yes in S1040) (Yes in S1041) the splitters 101a and 102a send data details of data buffers 101b and 102b, respectively. At the same time, each of the splitters 101a and 102a produces a signature of the data (S1100 and S1101). While the signature can be simply produced using, e.g., a checksum, the signature may also be produced using, e.g., CRC (Cyclic Redundancy Code) or LFSR (Linear Feedback Shift Register). After the data block is all stored in the data buffers 101b and 102b and the respective signatures are produced (S1110 and S1111), each of the splitters 101a and 102a searches the queue for the DMA request corresponding to the data block. The correspondence between the data block and the DMA request is confirmed based on an ID match.

If the DMA request having the same ID as the data block is found, each of the splitters 101a and 102a turns an F field among data fields, illustrated in FIG. 7, to be set, thus registering arrival of the data (S1120 and S1121). Further, each of the splitters 101a and 102a stores, in the Buffer Address field, the address of the data buffer in which the relevant data has been stored, and stores a value of the produced signature in the Signature field.

The comparator 103 (corresponding to a match determination unit) takes out elements from the head of each of the queue 0 and the queue 1 one by one and compares the taken-out elements with each other (S2010-S206) (S2011-S206). Herein, synchronization is established in units of logical I/O access instead of synchronization at a clock level. More specifically, the I/O access is buffered in a match detection circuit, and at the time when the I/O accesses from nodes are all obtained, a match between the I/O accesses is confirmed. By using such a synchronization method, the match detection can be performed with no need of establishing the synchronization at a clock level.

If the head element is a DMA request (Yes in S2020) (Yes in S2021), the comparator 103 checks the F flag (S2030 and S2031). If the F flag is not set (No in S2030) (No in S2031), the comparator 103 waits until the F flag is set.

If respective specifics of the I/O accesses are matched with each other as a result of comparing the elements taken out from the queue 0 and the queue 1 (Yes in S206), the comparator 103 sends the relevant I/O access to the device controller 105 (corresponding to an access control unit) whereby an actual operation of the I/O device is performed (S207).

On the other hand, if the respective specifics of the I/O accesses are not matched with each other as a result of the comparison (No in S206), the comparator 103 generates an error signal to notify the host 2 of the occurrence of an error.

In this embodiment, the determination as to whether a match is found or not is just made because there are only two virtual interfaces. However, three or more virtual interfaces may also be used. In such a case, whether to operate the I/O device or not can be determined by a method based on a majority vote.

A duplicator 106 is a unit for duplicating access from the I/O device 1 to the host 2. More specifically, the duplicator 106 duplicates access sent from the device controller 105 to the host 2 to form two accesses (S301 in FIG. 5). These two accesses are made respectively to the hosts (VM0 and VM1 herein) corresponding to the VIF0 and VIF1 (S3010-S3030 and S3011-S3031).

The device controller 105 is a unit for performing the actual operation of the I/O device 1. In some cases, the device controller 105 corresponds to a known I/O device itself.

The common block 107 is a unit for processing access to the physical construction of the I/O device 1. The common block 107 performs, for example, setting over the entire I/O device 1 and setting of the virtual interfaces.

Thus, this first embodiment solves the problems with the related art by newly introducing the following two schemes in the I/O device. The following two schemes are addressed respectively to the individual problems and are not always needed to be both employed at the same time.

<Connection Using Virtual Interfaces>

To detect a match between or among two or more inputs, two or more input ports are prepared. Hitherto, these input ports have been prepared as physical input ports. A PCI card-type I/O device in accordance with the PCI standards is equipped with a function called “multi-function”. This function enables physically one device to have different plural functions. With the “multi-function”, one physical device appears as a plurality of devices and as providing a plurality of interfaces when viewed from the exterior. Further, IOV (I/O Virtualization) of PCI Express defines a function called “virtual function”. With the “virtual function”, a plurality of virtual interfaces are prepared with respect to physically one I/O device such that the physically one I/O device can be shared by a plurality of units (or virtual machines). In other words, the “virtual function” is intended to separate I/O accesses from the plurality of units (or virtual interfaces) so as to prevent mixing of the I/O accesses. Thus, by employing any of the above-described functions, a plurality of interfaces can be prepared with respect to physically one I/O device.

In this first embodiment, the interfaces for performing the match verification are constructed by employing the “multi-function” that provides a plurality of different functions, or the “virtual function” that separates I/O accesses to prevent mixing of the I/O accesses.

Among plural interfaces provided by the “multi-function” or the “virtual function”, two or more interfaces are selected and correlated with each other. Access to each of the correlated interfaces is not immediately executed and is caused to wait until accesses are made to all the correlated interfaces. Upon the accesses being made to all the correlated interfaces, respective specifics of the I/O accesses are checked inside the I/O device. If the specifics of all the I/O accesses are matched with one another, the I/O device is actually operated. At that time, the access used for actually operating the I/O device may be selected by a majority vote instead of determining whether the specifics of all the I/O accesses are matched with one another. In such a modification, only the interface having received the I/O access, which has become a minority as a result of the majority vote, may be caused to generate an error.

The above-described scheme of virtual interfaces can also be incorporated in an I/O bridge. I/O accesses to various destinations pass through the I/O bridge. In the I/O bridge, a previously designated destination is selected and correlated. The destination may be the physical device number, or the number assigned in accordance with the “multi-function” or the “virtual function”. The I/O accesses to the correlated destination are caused to wait and are checked in a similar manner to the above-described case employing the I/O device. In the case of employing the I/O bridge, when a match is found, the I/O access is sent to the particular destination designated in advance.

<Scheme for Taking Access from I/O Device into Match Detection Circuit>

When access is made from the I/O device to a host memory, the access result is also needed to be subjected to the match check. Therefore, the I/O device or the I/O bridge used in this first embodiment includes a circuit for distributing the access from the I/O device to plural hosts and a circuit for taking the results returned from the hosts in response to the distributed accesses into the match check circuit.

If the access from the I/O device is a simple read, it is just required to take the access and the access result into the match check circuit. However, if the access from the I/O device is DMA, the operation is complicated. In the case of DMA, a data unit is large and a larger amount of processing is required to compare data when the data is processed as it is. In the DMA access, therefore, a signature (e.g., CRC or a checksum) produced from DMA data is compared instead of comparing the data. This enables a large amount of data, such as DMA data, to be compared at a reduced cost.

Further, this first embodiment employs a post-match-check operating method of executing the match check of the specifics of the I/O access and then driving the I/O device only after a match has been confirmed. Using the post-match-check operating method is advantageous in minimizing the influence caused by the occurrence of an error.

A second embodiment will be described below. The second embodiment is a modification of the above-described first embodiment. In the following second embodiment, components having similar functions to those described above in the first embodiment are denoted by the same reference numerals and a description of these components is omitted here.

In the first embodiment, as illustrated in FIG. 1, two interfaces VIF0 and VIF1 are employed as virtual interfaces of the I/O device. Further, as illustrated in FIG. 2, respective I/O accesses are stored in the queue 0 and the queue 1, respectively, and a match comparison between these I/O accesses is performed by the comparator 103.

In contrast, in the second embodiment, the I/O device includes three interfaces VIF0, VIF1 and VIF2 or more.

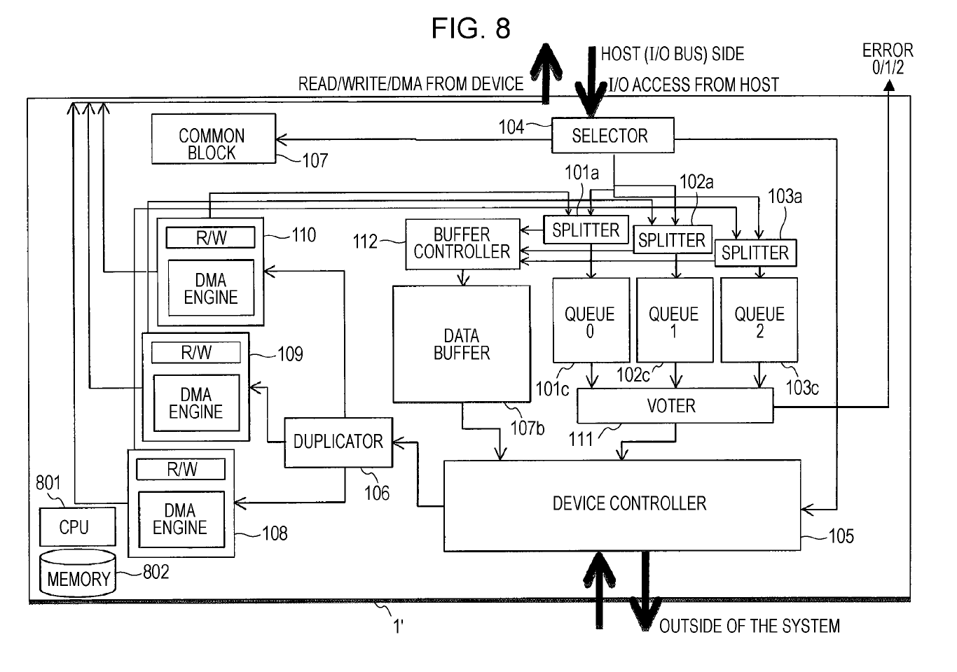

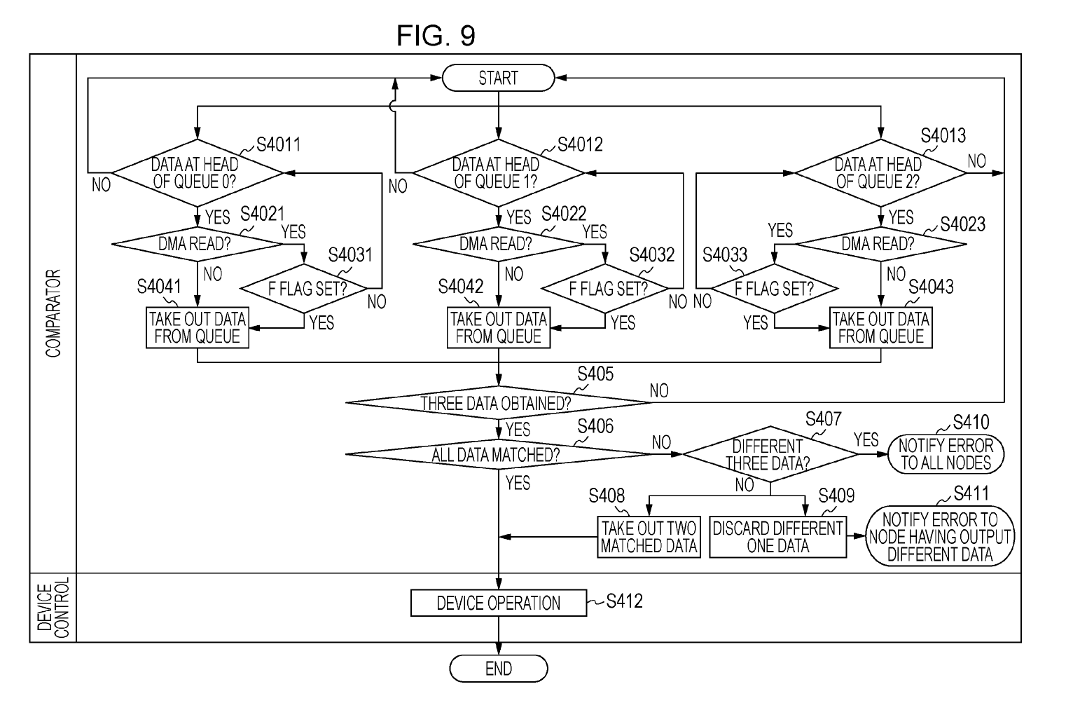

FIG. 8 illustrates a structure of an I/O device using three virtual interfaces according to the second embodiment. FIG. 9 is a flowchart illustrating an operation flow in a voter described below. Note that processing procedures in S4011-S4041, S4012-S4042, and S4013-S4043 in the flowchart of FIG. 9 are similar to those in S2010-S2040 of FIG. 4, and therefore a distribution of these procedures is omitted here.

As illustrated in FIG. 8, the number of queues is increased (i.e., queue 0 to queue 2) corresponding to the number of virtual interfaces. In FIG. 8, a splitter 101a, a queue 0 (101c), and a data buffer 107b correspond to the VIF0. A splitter 102a, a queue 1 (102c), and the data buffer 107b correspond to the VIF1. A splitter 103a, a queue 2 (103c), and the data buffer 107b correspond to the VIF2.

In this second embodiment, unlike the first embodiment, plural data buffers are integrated into the data buffer 107b, and a buffer controller 112 for controlling the data buffer 107b is provided. Such a configuration including the buffer controller 112 can also be similarly applied to the case employing two virtual interfaces. Conversely, the configuration using individual data buffers as illustrated in FIG. 2 may be applied to the case employing three or more virtual interfaces.

The match check circuit constituted as the comparator in FIG. 2 is modified in this second embodiment to a voter 111 (corresponding to a majority vote determination unit) that executes a majority vote. The voter 111 determines the I/O access, which is to be sent to the device controller 105, through a majority voting process (S405 to S409).

The I/O access having been determined to be a majority as a result of the majority vote is regarded as corresponding to the normal operation and is sent to the device controller 105 (S408 and S412). On the other hand, the I/O access having been determined to be a minority as a result of the majority vote is regarded as corresponding to the failed operation and is discarded away (S409). In the latter case, an error signal is sent to the source (VM0 or VM1 or VM2) having issued the I/O access, which is regarded as corresponding to the failed operation (S410 and S411).

In this second embodiment, because there are three virtual interfaces, the duplicator 106 produces three copies of I/O access corresponding to the number of virtual interfaces.

A third embodiment will be described below. The third embodiment is a modification of the above-described embodiments. In the following third embodiment, components having similar functions to those described above in the foregoing embodiments are denoted by the same reference numerals and a description of these components is omitted.

In the third embodiment, the circuit for executing the match check of the I/O access is incorporated in the I/O bridge.

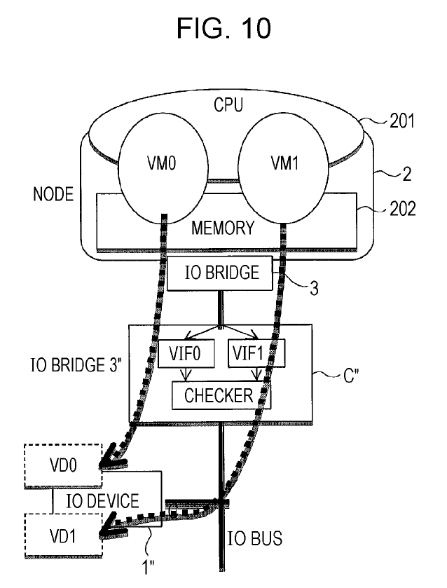

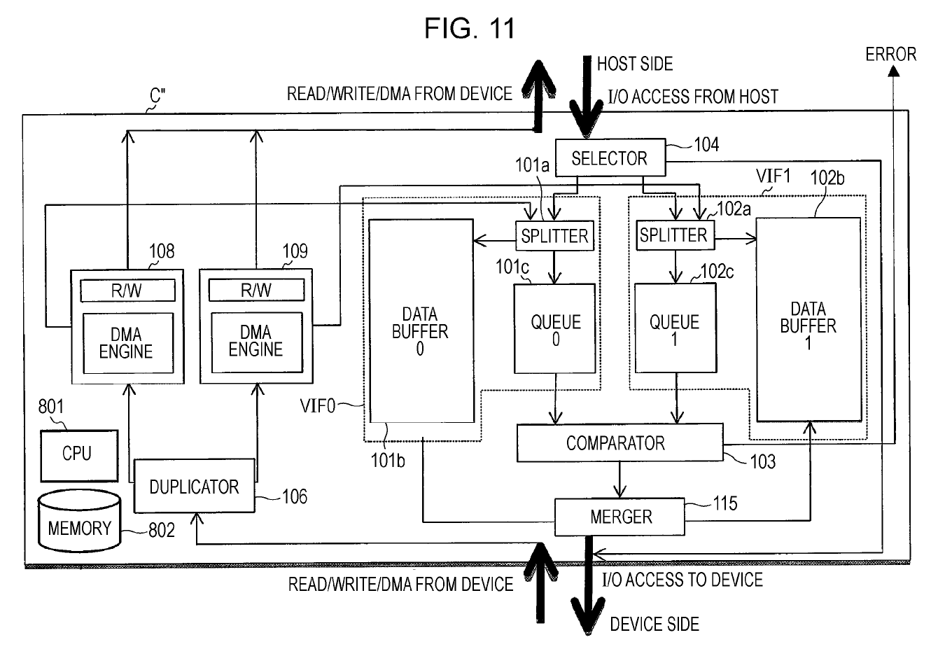

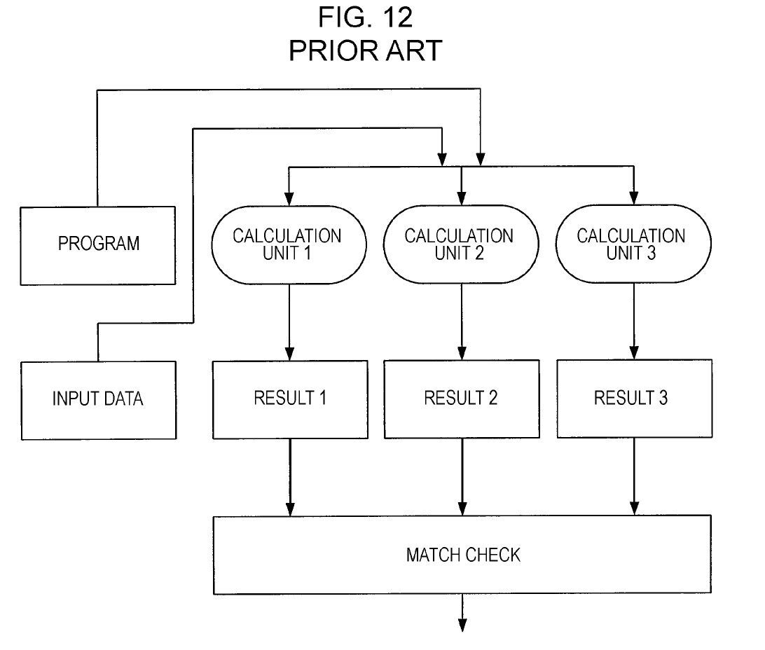

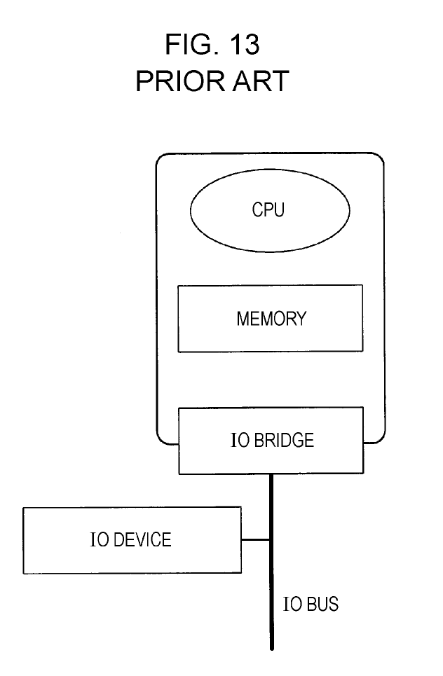

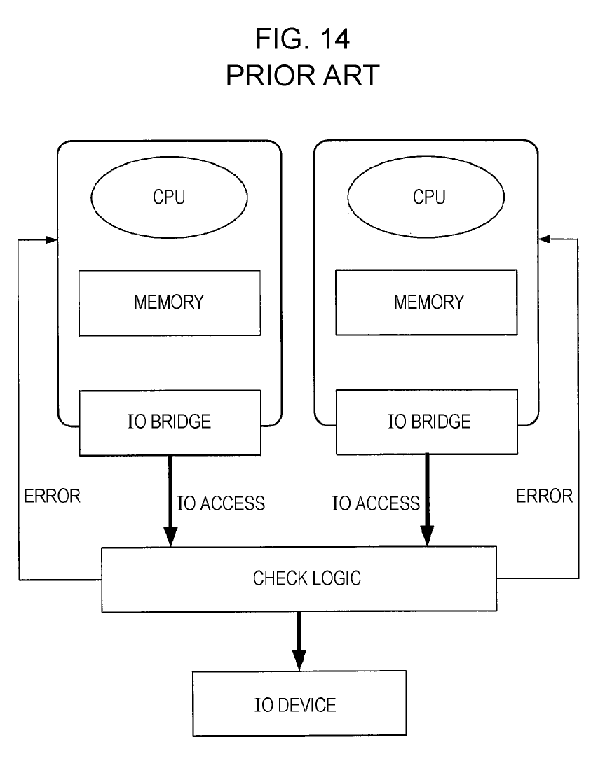

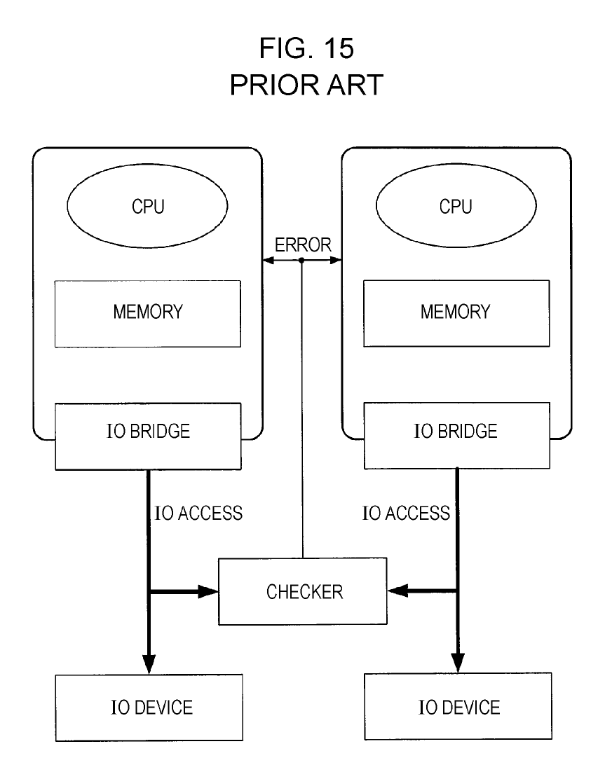

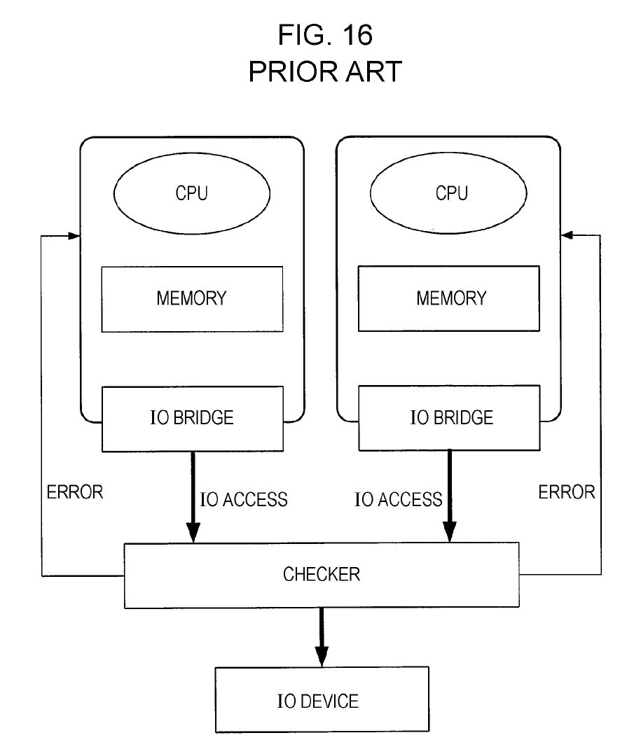

FIG. 10 illustrates an overall configuration of a multiplexing system including a communication control apparatus C″ according to the third embodiment, and FIG. 11 illustrates a detailed configuration of an I/O bridge 3″ illustrated in FIG. 10. In this third embodiment, as in the above-described first and second embodiments, two machines (VM0 and VM1) operate in the same manner on the physically one host 2. VM0 and VM1 share one I/O device 1″. Note that “VD” means Virtual Device in this third embodiment.

In the exemplary configuration illustrated in FIG. 10, two interfaces VIF0 and VIF1 are virtually prepared inside the IO bridge 3″. However, these two interfaces are not recognized by the host 2. The physically one I/O device appears as two I/O devices (VD0 and VD1) to the host. VD0 and VD1 are assigned respectively to VM0 and VM1 such that VM0 and VM1 utilize respectively VD0 and VD1 in an exclusive manner. In other words, VM0 accesses VD0 and VM1 accesses VD1.

In the above-described configuration, respective accesses from VM0 and VM1 to VD0 and VD1 are actually received by the virtual interfaces VIF0 and VIF1 disposed inside the IO bridge 3″. At the time when the I/O accesses to VIF0 and VIF1 are both obtained in the I/O bridge 3″, a checker in the I/O bridge 3″ compares respective specifics of the I/O accesses with each other to verify a match therebetween. If a match between the respective specifics of the I/O accesses is confirmed, the relevant I/O access is sent to the physical I/O device. If a match between the respective specifics of the I/O accesses is not confirmed, the I/O bridge 3″ notifies the occurrence of an error to the host 2.

The basic operation of the I/O bridge 3″ is similar to the operation of the I/O device 1 described in the first embodiment (see FIG. 2). More specifically, I/O accesses are distributed by the selector 104 such that, if the I/O accesses are destined for VIF0 and VIF1, the specifics of the I/O accesses are stored respectively in the queue 0 and the queue 1 and are then subjected to the match check by the comparator 103 (see the flowcharts of FIGS. 3 and 4).

While I/O accesses to various destinations arrive the I/O bridge 3″, the other I/O accesses than those destined for VD0 and VD1 are transferred to the I/O bus connected at the output side by the selector 104.

The operation in accessing the host from the I/O device is also similar to that in the first embodiment. More specifically, the I/O access is duplicated by the duplicator 106 to produce I/O accesses destined for the respective VMs. If access is a DMA read, the access is registered in the queue and the match check is executed after waiting return of the result of the DMA read (see the flowchart of FIG. 5).

This third embodiment differs from the first embodiment in that a merger 115 is included instead of the device controller 105. The merger 115 has a function of coupling a command and data which have been separated by the splitter. More specifically, if the I/O access having been stored in the queue and confirmed on a match of the access specifics by the comparator 103 is DMA access, the merger 115 takes in data from the address registered in the “Buffer Address” field and sends the data to the I/O device after coupling the data with the relevant command.

Further, a program for executing the above-described steps on a computer constituting a communication control apparatus can be provided as a communication control program. The program can be executed by the computer constituting the communication control apparatus by storing the program in a computer readable recording medium (e.g., a memory 802). Examples of the recording medium readable by the computer (e.g., a CPU 801) include an internal memory incorporated in the computer, such as a ROM or a RAM, a portable storage medium such as a CD-ROM, a flexible disk, a DVD disk, a magneto-optical disk or an IC card, a database storing a computer program, another computer, and a database in the other computer.

Thus, the above-described steps in the communication control method can be realized by causing, for example, the CPU 801 to execute the communication control program.

According to the above-described embodiments, an overhead to reliably execute processing can be reduced and the processing can be realized with higher reliability than that of the known configuration without increasing the cost of physical hardware.

Further, according to the above-described embodiments, reliable multiplex execution can be realized by using only one physical host. Moreover, because imaginary machines are employed and just one physical interface is required, the multiplex execution can be realized even in an environment having only one hardware unit. As a result, the multiplex execution for performing a match check with hardware, which has hitherto been costly to implement, can be performed at a lower cost.

While the embodiments have been primarily described above in connection with the case that the communication control apparatus is incorporated in the I/O device or the I/O bridge, the present invention is not limited to those embodiments. Still another embodiment can be provided as a highly reliable system (including a host terminal) which has the I/O device or the I/O bridge equipped with the above-described communication control apparatus.

Hitherto, the match check has been performed only on the access from the host to the I/O device. However, the match check of the I/O access from the I/O device to the host, which has been impossible to implement with the related art, can be realized by applying, to the match check circuit, the I/O access from the I/O device to the host as described above in the embodiments. As a result, the match check of a DMA read from the I/O device can also be performed and a more reliable system can be constructed.

While the present invention has been described in detail in connection with specific embodiments, it is apparent to those skilled in the art that the present invention can be practiced in variously modified and altered forms without departing from the gist and the scope of the invention.

What is claimed is:

1. A communication control apparatus comprising:
a communication terminal capable of performing communication with an external apparatus;
a plurality of virtual interfaces for separately receiving, through the communication terminal, plural sets of access information representing respective specifics of I/O accesses which are output to one I/O device from a plurality of virtual processing units in the external apparatus;
a match determination unit for comparing the plural sets of access information received from the external apparatus by the plurality of virtual interfaces, and determining whether the plural sets of access information are matched with each other; and
an access control unit for, when the match determination unit determines that the plural sets of access information received by the plurality of virtual interfaces are matched with each other, sending the relevant access information to the I/O device that is an access destination of the relevant access information.

2. The communication control apparatus according to claim 1, further comprising:
a majority vote determination unit for, when the match determination unit determines that the plural sets of access information received by the plurality of virtual interfaces are not matched with each other, selecting the access information that is determined to be a majority between or among the plural sets of access information by a majority vote,
wherein the access control unit sends the access information selected by the majority vote determination unit to the I/O device that is the access destination of the selected access information.

3. A communication control apparatus comprising:
a communication terminal capable of performing communication with an external apparatus;
a plurality of virtual interfaces for separately receiving, through the communication terminal, respective data transmitted to one I/O device from a plurality of virtual processing units in the external apparatus, the data being transmitted from the external apparatus in accordance with a request from the I/O device;
a match determination unit for comparing the plural data received from the external apparatus by the plurality of virtual interfaces, and determining whether the plural data are matched with each other; and
an access control unit for, when the match determination unit determines that the plural data received by the plurality of virtual interfaces are matched with each other, sending the relevant data to the I/O device that is a transmission destination of the relevant data.

4. The communication control apparatus according to claim 3, further comprising:
a majority vote determination unit for, when the match determination unit determines that the plural data received by the plurality of virtual interfaces are not matched with each other, selecting the data that is determined to be a majority between or among the plural data by a majority vote,
wherein the access control unit sends the data selected by the majority vote determination unit to the I/O device that is the transmission destination of the selected data.

5. The communication control apparatus according to claim 3, wherein the match determination unit determines whether the plural data received by the plurality of virtual interfaces are matched with each other, based on signatures produced from the respective data.

6. A communication control method for use in a communication control apparatus comprising a communication terminal capable of performing communication with an external apparatus, and a plurality of virtual interfaces for separately receiving, through the communication terminal, plural sets of access information representing respective specifics of I/O accesses which are output to one I/O device from a plurality of virtual processing units in the external apparatus, the communication control method comprising:
a match determination procedure of comparing the plural sets of access information received from the external apparatus by the plurality of virtual interfaces, and determining whether the plural sets of access information are matched with each other; and
an access control procedure of, when the match determination procedure determines that the plural sets of access information received by the plurality of virtual interfaces are matched with each other, sending the relevant access information to an I/O device that is an access destination of the relevant access information.

7. The communication control method according to claim 6, further comprising:
a majority vote determination procedure of, when the match determination procedure determines that the plural sets of access information received by the plurality of virtual interfaces are not matched with each other, selecting the access information that is determined to be a majority between or among the plural sets of access information by a majority vote,
wherein the access control procedure sends the access information selected in the majority vote determination procedure to the I/O device that is the access destination of the selected access information.
